(19) United States
(12) Patent Application Publication
(10) Pub. No.: US 2024/0101070 A1
(43) Pub. Date: Mar. 28, 2024

(54) CLEANER SYSTEM

(71) Applicant: KOITO MANUFACTURING CO., LTD., Tokyo (JP)

(72) Inventor: Tatsuya INOUE, Shizuoka-shi, Shizuoka (JP)

(73) Assignee: KOITO MANUFACTURING CO., LTD., Tokyo (JP)

(21) Appl. No.: 18/267,383

(22) PCT Filed: Nov. 19, 2021
(86) PCT No.: PCT/JP2021/042648

§ 371 Date: Jun. 14, 2023

(30) Foreign Application Priority Data
Dec. 16, 2020 (JP) 2020-208340

(51) Int. Cl. B60S 1/52; B60S 1/54

(52) U.S. Cl. CPC B60S 1/52; B60S 1/54

(57) ABSTRACT

A cleaner system for cleaning a sensor mounted on a vehicle includes a first cleaner unit configured to clean a first sensor, a second cleaner unit configured to clean a second sensor different from the first sensor, and a solenoid valve configured to switch a duct of a cleaning medium supplied from a supply source. The solenoid valve is switchable such that the duct is connected to the first cleaner unit during non-energization, and the duct is connected to the second cleaner unit during energization, and the first sensor is provided in front of the second sensor in the vehicle.

### TECHNICAL FIELD

The present disclosure relates to a cleaner system.

### BACKGROUND ART

In recent years, cameras have been mounted on vehicles. The camera outputs acquired information to a vehicle ECU or the like that controls an own vehicle. A vehicle cleaner capable of cleaning such a camera with a cleaning liquid is known (see Patent Literature 1).

### CITATION LIST

### Patent Literature

Patent Literature 1: JP2001-171491A

### SUMMARY OF INVENTION

### Technical Problem

A plurality of cameras and sensors are mounted on a vehicle. It is conceivable to clean the plurality of cameras and sensors with the above-described vehicle cleaner. In this case, the plurality of vehicle cleaners may be integrated as a vehicle cleaner system and mounted on the vehicle.

When such a vehicle cleaner system is implemented, it is necessary to transport a cleaning medium from a tank storing the cleaning medium to each cleaner unit, and a large number of solenoid valves are required. Accordingly, since the large number of solenoid valves are used in the vehicle cleaner system, it is desirable to reduce power consumption of the solenoid valves as much as possible.

An object of the present disclosure is to provide a cleaner system having low power consumption.

### Solution to Problem

In order to achieve the above object, a cleaner system according to an aspect of the present invention is a cleaner system for cleaning a sensor mounted on a vehicle and includes:
a first cleaner unit configured to clean a first sensor;
a second cleaner unit configured to clean a second sensor different from the first sensor; and
a solenoid valve configured to switch a duct of a cleaning medium supplied from a supply source, in which
the solenoid valve is switchable such that the duct is connected to the first cleaner unit during non-energization, and the duct is connected to the second cleaner unit during energization, and
the first sensor is provided in front of the second sensor in the vehicle.

The first sensor provided in front of the second sensor in the vehicle has higher importance than the second sensor since the first sensor detects an object or the like in a traveling direction of the vehicle. It is assumed that the first sensor having high importance needs to be cleaned more frequently than the second sensor. According to the above configuration, since the first sensor can be cleaned without energizing the solenoid valve, the power consumption of the solenoid valve can be reduced. Further, since the first sensor is cleaned during non-energization, the first sensor having high importance can be cleaned even if the solenoid valve fails.

Further, in order to achieve the above object, a cleaner system according to an aspect of the present invention is a cleaner system for cleaning a sensor mounted on a vehicle and includes:
a first cleaner unit configured to clean a first sensor;
a second cleaner unit configured to clean a second sensor different from the first sensor; and
a solenoid valve configured to switch a duct of a cleaning medium supplied from a supply source, in which
the solenoid valve is switchable such that the duct is connected to the first cleaner unit during non-energization, and the duct is connected to the second cleaner unit during energization, and
the first sensor is provided below the second sensor in the vehicle.

Since the first sensor provided below the second sensor in the vehicle is closer to the ground than the second sensor, the first sensor is easily contaminated. Accordingly, the first sensor is preferably cleaned more frequently than the second sensor. According to the above configuration, since the first sensor can be cleaned without energizing the solenoid valve, the power consumption of the solenoid valve can be reduced.

Further, in order to achieve the above object, a cleaner system according to an aspect of the present invention is a cleaner system for cleaning a sensor mounted on a vehicle and includes:
a first cleaner unit configured to clean a first sensor;
a second cleaner unit configured to clean a second sensor different from the first sensor; and
a solenoid valve configured to switch a duct of a cleaning medium supplied from a supply source, in which
the solenoid valve is switchable such that the duct is connected to the first cleaner unit during non-energization, and the duct is connected to the second cleaner unit during energization, and
the first sensor has a larger horizontal angle in a detection range than the second sensor.

According to the above configuration, since the first sensor having a detection range larger than that of the second sensor has higher importance than the second sensor, it is assumed that cleaning is frequently required. According to the above configuration, since the first sensor can be cleaned without energizing the solenoid valve, the power consumption of the solenoid valve can be reduced. Further, since the first sensor is cleaned during non-energization, the first sensor having high importance can be cleaned even if the solenoid valve fails.

### Advantageous Effects of Invention

According to the present disclosure, the cleaner system having low power consumption can be provided.

### BRIEF DESCRIPTION OF DRAWINGS

FIG. 1 is a diagram illustrating a vehicle on which a cleaner system according to an embodiment of the present disclosure is mounted.

FIG. 2 is a system configuration diagram of the cleaner system according to an embodiment of the present disclosure.

FIG. 3 is a diagram illustrating a vehicle on which a cleaner system according to an embodiment of the present disclosure is mounted.

FIG. 4 is a diagram illustrating a vehicle on which a cleaner system according to an embodiment of the present disclosure is mounted.

### DESCRIPTION OF EMBODIMENTS

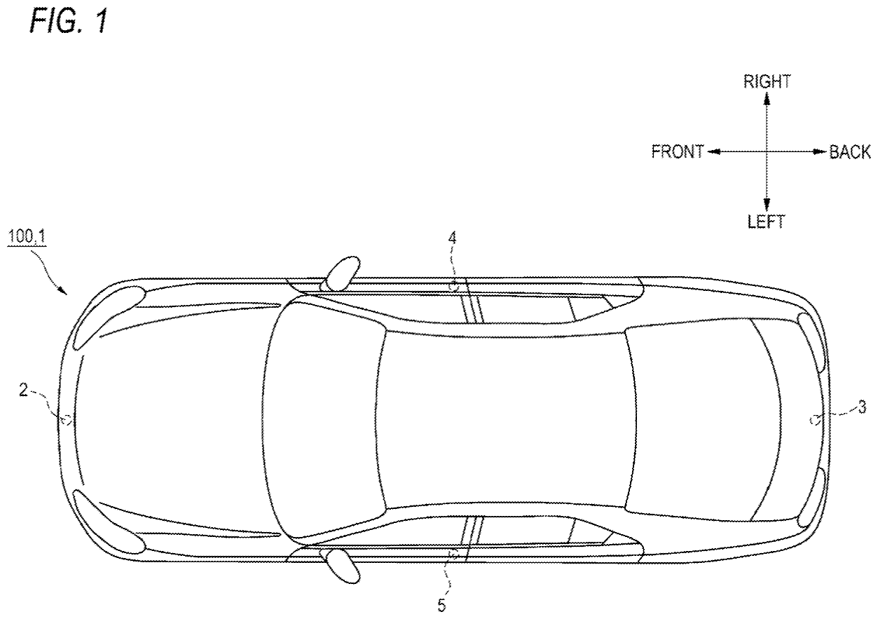

Hereinafter, an example of embodiments of the present disclosure will be described with reference to the drawings. In the description of the present embodiment, for convenience of description, a “front-back direction”, a “left-right direction”, and an “up-down direction” will be appropriately referred to. These directions are relative directions set for a vehicle 100 illustrated in FIG. 1. Here, the “up-down direction” includes an “up direction” and a “down direction”. The “front-back direction” includes a “front direction” and a “back direction”. The “left-right direction” includes a “left direction” and a “right direction”.

### First Embodiment

The vehicle 100 on which a cleaner system 1 according to the present embodiment is mounted will be described below with reference to FIG. 1. FIG. 1 is a diagram illustrating the vehicle 100 on which the cleaner system 1 is mounted. The vehicle 100 includes a front sensor 2 (an example of a first sensor), a rear sensor 3 (an example of a second sensor), a right sensor 4 (an example of the second sensor), and a left sensor 5 (an example of the second sensor). The sensors 2 to 5 are, for example, a LiDAR or a camera. The LiDAR is a sensor that acquires surrounding environment information in a predetermined direction of the vehicle 100 by acquiring information such as a distance to an object and a shape of the object based on an emitted light and a returned light. The surrounding environment information is, for example, information related to other vehicles, pedestrians, road shapes, traffic signs, obstacles, or the like. The camera is a sensor that acquires the surrounding environment information in the predetermined direction of the vehicle 100 by capturing a situation (an image) in the predetermined direction of the vehicle 100.

The front sensor 2 is disposed in the front of the vehicle 100. The rear sensor 3 is disposed in the back of the vehicle 100. The right sensor 4 is disposed on a right side surface of the vehicle 100. The left sensor 5 is disposed on a left side surface of the vehicle 100. Therefore, the front sensor 2 is disposed at the most front of the vehicle 100, the rear sensor 3 is disposed at the most rear of the vehicle 100, the right sensor 4 and the left sensor 5 are disposed between the front sensor 2 and the rear sensor 3 in the front-back direction of the vehicle 100.

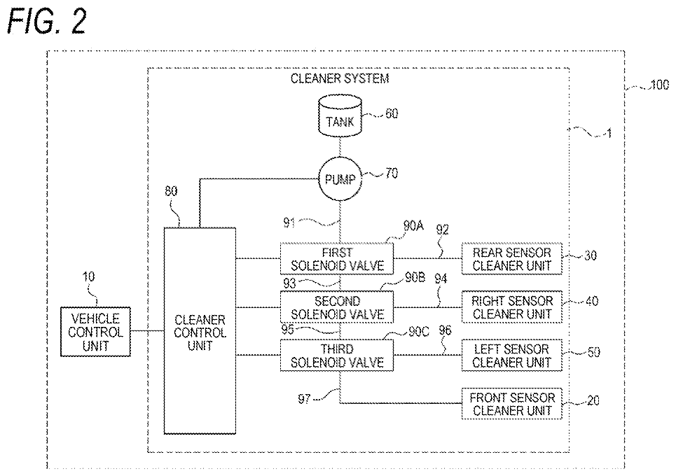

Next, the cleaner system 1 will be described with reference to FIG. 2. As illustrated in FIG. 2, the vehicle 100 includes a cleaner system 1 and a vehicle control unit 10. The cleaner system 1 is a system that removes foreign matter such as water droplets, mud, and dust adhering to a cleaning object by using a cleaning medium. The cleaner system 1 includes a front sensor cleaner unit 20 (an example of a first cleaner unit), a rear sensor cleaner unit 30 (an example of a second cleaner unit), a right sensor cleaner unit 40 (an example of a second cleaner unit), a left sensor cleaner unit 50 (an example of a second cleaner unit), a tank 60 (an example of a supply source), a pump 70, a cleaner control unit 80, a first solenoid valve 90A, a second solenoid valve 90B, and a third solenoid valve 90C.

The vehicle control unit 10 is configured to control traveling of the vehicle 100. The vehicle control unit 10 includes an electronic control unit (ECU). The electronic control unit includes a processor such as a central processing unit (CPU), a read only memory (ROM) in which various vehicle control programs are stored, and a random access memory (RAM) in which various kinds of vehicle control data are temporarily stored. The processor is configured to load a program designated from various vehicle control programs stored in the ROM on the RAM and execute various processes in cooperation with the RAM. The vehicle control unit 10 acquires the surrounding environment information of the vehicle 100 from various sensors (including the sensors 2 to 5 and sensors other than the sensors 2 to 5) provided in the vehicle 100, and specifies a sensor to be cleaned among the sensors 2 to 5 based on the surrounding environment information. When the sensor to be cleaned is specified, the vehicle control unit generates an instruction signal and transmits the generated instruction signal to the cleaner control unit 80.

The front sensor cleaner unit 20 can clean the front sensor 2. The rear sensor cleaner unit 30 can clean the rear sensor 3. The right sensor cleaner unit 40 can clean the right sensor 4. The left sensor cleaner unit 50 can clean the left sensor 5. Each cleaner has one or more nozzles, and discharges a cleaning liquid or the cleaning medium such as air from the nozzles toward the cleaning object.

The tank 60 is configured to store the cleaning medium. The tank 60 is configured to supply the stored cleaning medium to each of the sensor cleaner units 20, 30, 40, and 50 via the pump 70.

The pump 70 is configured to pump the cleaning medium in the tank 60. The sensor cleaner units 20, 30, 40, and 50 are connected to the tank 60 via the pump 70, and the pump 70 sends the cleaning medium stored in the tank 60 to the sensor cleaner units 20, 30, 40, and 50.

The cleaner control unit 80 may have a hardware configuration similar to that of the vehicle control unit 10, for example. The cleaner control unit 80 is communicably connected to the vehicle control unit 10, the pump 70, and the first to third solenoid valves 90A to 90C. The cleaner control unit 80 generates a control signal for operating each of the sensor cleaner units 20, 30, 40, and 50, for example, based on an instruction signal received from the vehicle control unit 10 through controller area network (CAN) communication. The cleaner control unit 80 outputs the generated control signal to the first to third solenoid valves 90A to 90C. The cleaner control unit 80 controls the pump 70 based on the instruction signal received from the vehicle control unit 10 through the CAN communication.

The first to third solenoid valves 90A to 90C are valves that can be controlled to be opened and closed by an electric signal, and for example, valves whose valve bodies are driven by a solenoid. The first to third solenoid valves 90A to 90C can select the sensor cleaner unit 20, 30, 40, or 50 to which the cleaning medium supplied from the pump 70 flows by switching opening and closing of the valves.

In the present embodiment, the first to third solenoid valves 90A to 90C are all normally closed valves. The first solenoid valve 90A is connected to a first duct 91 extending from the pump, a second duct 92 extending to the rear sensor cleaner unit 30, and a third duct 93. When the first solenoid valve 90A is in a closed state, the first duct 91 and the third duct 93 are connected, and the first duct 91 and the second duct 92 are blocked. When the first solenoid valve 90A is in an open state, the first duct 91 and the second duct 92 are connected, and the first duct 91 and the third duct 93 are blocked. The second solenoid valve 90B is connected to the third duct 93 extending from the first solenoid valve 90A, a fourth duct 94 extending to the right sensor cleaner unit 40, and a fifth duct 95. When the second solenoid valve 90B is in a closed state, the third duct 93 and the fifth duct 95 are connected, and the third duct 93 and the fourth duct 94 are blocked. When the second solenoid valve 90B is in an open state, the third duct 93 and the fourth duct 94 are connected, and the third duct 93 and the fifth duct 95 are blocked. The third solenoid valve 90C is connected to the fifth duct 95 extending from the second solenoid valve 90B, a sixth duct 96 extending to the left sensor cleaner unit 50, and a seventh duct 97 extending to the front sensor cleaner unit 20. When the third solenoid valve 90C is in a closed state, the fifth duct 95 and the seventh duct 97 are connected, and the fifth duct 95 and the sixth duct 96 are blocked. When the third solenoid valve 90C is in an open state, the fifth duct 95 and the sixth duct 96 are connected, and the fifth duct 95 and the seventh duct 97 are blocked.

For example, when the rear sensor cleaner unit 30 is cleaned, the vehicle control unit generates the instruction signal for cleaning the rear sensor cleaner unit 30 and transmits the instruction signal to the cleaner control unit 80. The cleaner control unit 80 sets the second solenoid valve 90B and the third solenoid valve 90C to the closed state and the first solenoid valve 90A to the open state based on the instruction signal. Accordingly, the cleaning medium supplied from the pump 70 does not flow to the third duct 93, but flows only to the second duct 92, and the cleaning medium is supplied to the rear sensor cleaner unit 30.

Since the large number of solenoid valves are used in the cleaner system provided in the vehicle, it is desired to reduce power consumption of the solenoid valves as much as possible. Therefore, the inventor has conceived that the power consumption of the solenoid valves can be reduced if the cleaning medium is designed to be fed to the cleaner unit cleaning a sensor that has high importance and often has high cleaning frequency during non-energization.

Since the front sensor 2 provided at the foremost position in the front-back direction of the vehicle 100 is located in a traveling direction of the vehicle, the front sensor 2 has higher importance than other sensors, and the cleaning frequency is often higher. According to the cleaner system 1 having the above-described configuration, since the front sensor 2 having the highest cleaning frequency can be cleaned without energizing the first to third solenoid valves 90A to 90C, the power consumption of the solenoid valves can be reduced. Further, since the front sensor 2 is cleaned during the non-energization, even if the first to third solenoid valves 90A to 90C fail, the front sensor 2 having high importance can be cleaned. The term “failure” may include an electrical failure and a mechanical failure.

A detection range of the front sensor 2 is a region forward of detections ranges of the other sensors 3 to 5 in the vehicle 100. Accordingly, the front sensor 2 has higher importance and cleaning frequency than the other sensors 3 to 5. According to the cleaner system 1 having the above-described configuration, since the front sensor 2 having high cleaning frequency can be cleaned without energizing the first to third solenoid valves 90A to 90C, the power consumption of the solenoid valves can be reduced. Further, since the front sensor 2 is cleaned during the non-energization, even if the first to third solenoid valves 90A to 90C fail, the front sensor 2 having high importance can be cleaned.

### Second Embodiment

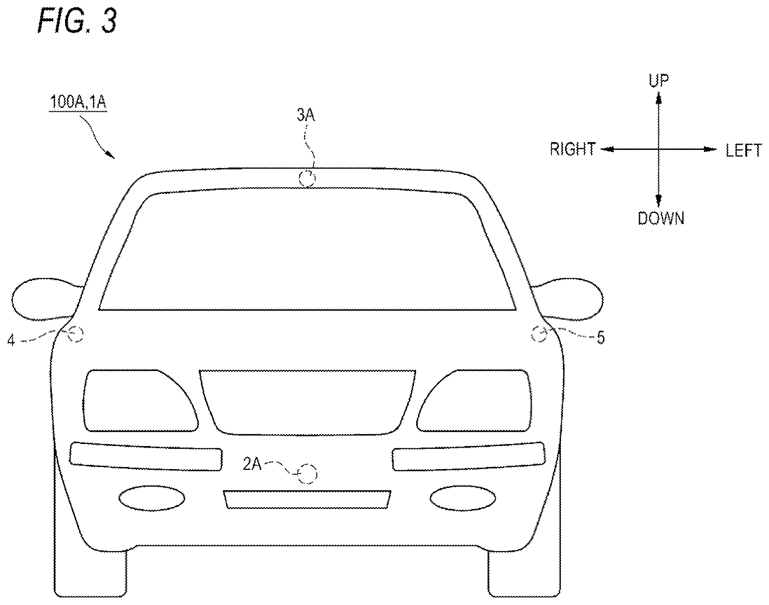

Next, a second embodiment will be described with reference to FIG. 3. Note that, in the description of the second embodiment, a description of portions overlapping the description in the first embodiment will be appropriately omitted. FIG. 3 is a diagram illustrating a vehicle 100A on which the cleaner system 1A is mounted. As illustrated in FIG. 3, the second embodiment is different from the first embodiment in that a lower sensor 2A and an upper sensor 3A are provided instead of the front sensor 2 and the rear sensor 3. The lower sensor 2A is disposed on a front lower side of the vehicle 100A, and the upper sensor 3A is disposed on a front upper side of the vehicle 100A.

Since the sensor provided on a lower side of the vehicle is closer to the ground than the sensor provided on an upper side of the vehicle, the sensor is easily contaminated. Accordingly, the sensor provided on the lower side of the vehicle is preferably cleaned more frequently than the sensor provided on the upper side of the vehicle. Therefore, the inventor has conceived that power consumption of the solenoid valves can be reduced if the cleaning medium is designed to be fed to the cleaner unit cleaning the sensor that has the high cleaning frequency during non-energization.

According to the cleaner system 1A having the above-described configuration, since the lower sensor 2A having the highest cleaning frequency can be cleaned without energizing the first to third solenoid valves 90A to 90C, the power consumption of the solenoid valves can be reduced.

### Third Embodiment

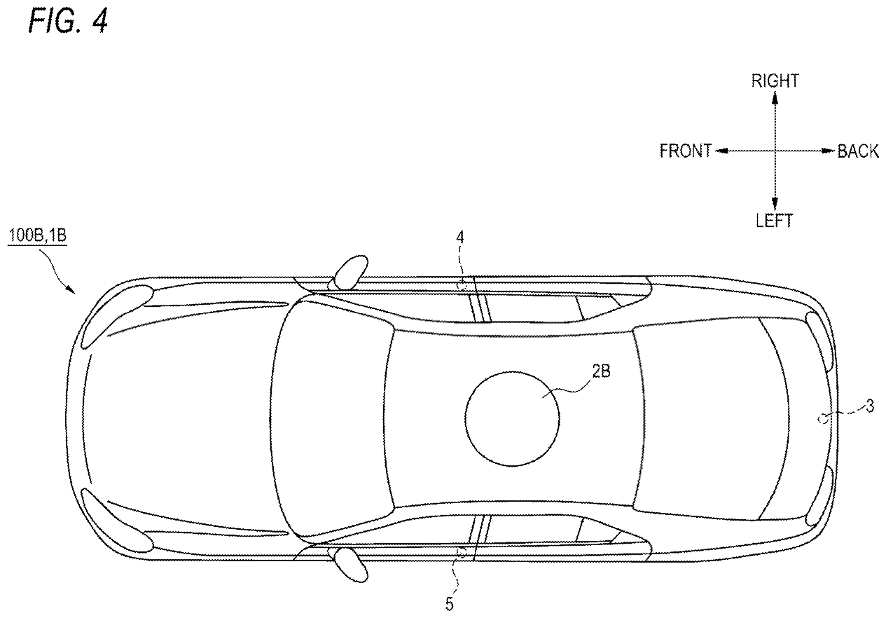

Next, a third embodiment will be described with reference to FIG. 4. Note that, in the description of the third embodiment, a description of portions overlapping the description in the first embodiment will be appropriately omitted. FIG. 4 is a diagram illustrating a vehicle 100B on which the cleaner system 1B is mounted. As illustrated in FIG. 4, the third embodiment is different from the first embodiment in that a roof sensor 2B is provided instead of the front sensor 2.

The roof sensor 2B is provided on a roof of the vehicle 100B. The roof sensor 2B is a sensor that acquires surrounding environment information around the vehicle 100B, and a horizontal angle in a detection range thereof is, for example, 0° to 360°. The roof sensor 2B has a larger horizontal angle in the detection range than the other sensors 3 to 5.

Since a sensor having a large horizontal angle in the detection range has a wide detection range, the sensor has higher importance than a sensor having a small horizontal angle in the detection range and is likely to have high cleaning frequency. Therefore, the inventor has considered that power consumption of the solenoid valves can be reduced by designing the cleaning medium to be fed to the cleaner unit cleaning the sensor that has the large horizontal angle in the detection range during non-energization.

According to the cleaner system 1B having the above-described configuration, since the roof sensor 2B having the high cleaning frequency is cleaned during the non-energization, the power consumption of the solenoid valves can be reduced. Further, according to the cleaner system 1B having the above-described configuration, even if the first to third solenoid valves 90A to 90C fail, the roof sensor 2B having high importance can be cleaned.

The above-described embodiments are for facilitating understanding of the present disclosure, and does not limit the present disclosure. The present disclosure can be modified or improved without departing from the gist thereof.

The LiDAR acquires more surrounding environment information than the camera. In the above-described embodiment, when the front sensor 2, the lower sensor 2A, or the roof sensor 2B is a LiDAR and the other sensors 3 to 5 and 3A are cameras, the cleaner systems 1, 1A, and 1B can clean the front sensor 2, the lower sensor 2A, or the roof sensor 2B without energizing the first to third solenoid valves 90A to 90C. Accordingly, the power consumption of the solenoid valves can be reduced.

In the above embodiment, the vehicle control unit 10 and the cleaner control unit 80 are separate control units, but the vehicle control unit 10 may perform a process of the cleaner control unit 80 to integrate the control units.

In the above-described embodiments, the first solenoid valve 90A is a solenoid valve by which the first duct 91 and the third duct 93 communicate with each other and the first duct 91 and the second duct 92 are blocked in the closed state, and by which the first duct 91 and the second duct 92 communicate with each other and the first duct 91 and the third duct 93 are blocked in the open state. For example, the first solenoid valve 90A may be a solenoid valve by which the first duct 91 and the third duct 93 communicate with each other and the first duct 91 and the second duct 92 are blocked in the closed state, and by which the first duct 91 and the second duct 92 communicate with each other and the first duct 91 and the third duct 93 communicate with each other in the open state. The second solenoid valve 90B and the third solenoid valve 90C may be the same as the first solenoid valve 90A.

The sensor cleaned during the non-energization may be set in consideration of a mounting position of the sensor, a type of the sensor, the detection range of the sensor, the horizontal angle set in the detection range of the sensor, or the like in a comprehensive (composite) manner. For example, when the detection range of the front sensor 2, the lower sensor 2A, or the roof sensor 2B is set to a region forward of the detection ranges of the other sensors 3 to 5 and 3A when viewed from the vehicles 100, 100A, and 100B, the cleaner systems 1, 1A, and 1B may be set to clean the front sensor 2, the lower sensor 2A, or the roof sensor 2B without energizing the first to third solenoid valves 90A to 90C. Further, for example, when the detection range of the front sensor 2, the lower sensor 2A, or the roof sensor 2B is wider than the detection ranges of the other sensors 3 to 5 and 3A, the cleaner systems 1, 1A, and 1B may be set to clean the front sensor 2, the lower sensor 2A, or the roof sensor 2B without energizing the first to third solenoid valves 90A to 90C. Further, for example, when the detection range of the front sensor 2, the lower sensor 2A, or the roof sensor 2B which is the LiDAR is set to a region forward of the detection ranges of the other sensors 3 to 5 and 3A which are the cameras when viewed from the vehicles 100, 100A, and 100B, the cleaner systems 1, 1A, and 1B may be set to clean the front sensor 2, the lower sensor 2A, or the roof sensor 2B without energizing the first to third solenoid valves 90A to 90C. Further, for example, when the detection range of the front sensor 2, the lower sensor 2A, or the roof sensor 2B which is the LiDAR is wider than the detection ranges of the other sensors 3 to 5 and 3A which are the cameras, the cleaner systems 1, 1A, and 1B may be set to clean the front sensor 2, the lower sensor 2A, or the roof sensor 2B without energizing the first to third solenoid valves 90A to 90C. Further, for example, in a case where the detection range of the front sensor 2, the lower sensor 2A, or the roof sensor 2B is set to a region forward of the detection ranges of the other sensors 3 to 5 and 3A when viewed from the vehicles 100, 100A, and 100B, and the detection range of the front sensor 2, the lower sensor 2A, or the roof sensor 2B is wider than the detection ranges of the other sensors 3 to 5 and 3A, the cleaner systems 1, 1A, and 1B may be set to clean the front sensor 2, the lower sensor 2A, or the roof sensor 2B without energizing the first to third solenoid valves 90A to 90C. In addition, for example, in a case where the detection range of the front sensor 2, the lower sensor 2A, or the roof sensor 2B which is the LiDAR is set to a region forward of the detection ranges of the other sensors 3 to 5 and 3A which are the cameras when viewed from the vehicles 100, 100A, and 100B, and the detection range of the front sensor 2, the lower sensor 2A, or the roof sensor 2B is wider than the detection ranges of the other sensors 3 to 5 and 3A, the cleaner systems 1, 1A, and 1B may be set to clean the front sensor 2, the lower sensor 2A, or the roof sensor 2B without energizing the first to third solenoid valves 90A to 90C.

The present application is based on a Japanese patent application (Japanese Patent Application No. 2020-208340) filed on Sep. 16, 2020, and the contents thereof are incorporated herein by reference.

1. A cleaner system for cleaning a sensor mounted on a vehicle, the cleaner system comprising:
a first cleaner unit configured to clean a first sensor;
a second cleaner unit configured to clean a second sensor different from the first sensor; and
a solenoid valve configured to switch a duct of a cleaning medium supplied from a supply source,
wherein the solenoid valve is switchable such that the duct is connected to the first cleaner unit during non-energization, and the duct is connected to the second cleaner unit during energization, and
wherein the first sensor is provided in front of the second sensor in the vehicle.

2. A cleaner system for cleaning a sensor mounted on a vehicle, the cleaner system comprising:
a first cleaner unit configured to clean a first sensor,
a second cleaner unit configured to clean a second sensor different from the first sensor; and
a solenoid valve configured to switch a duct of a cleaning medium supplied from a supply source,
wherein the solenoid valve is switchable such that the duct is connected to the first cleaner unit during non-energization, and the duct is connected to the second cleaner unit during energization, and
wherein the first sensor is provided below the second sensor in the vehicle.

3. A cleaner system for cleaning a sensor mounted on a vehicle, the cleaner system comprising:
a first cleaner unit configured to clean a first sensor;
a second cleaner unit configured to clean a second sensor different from the first sensor; and
a solenoid valve configured to switch a duct of a cleaning medium supplied from a supply source,
wherein the solenoid valve is switchable such that the duct is connected to the first cleaner unit during non-energization, and the duct is connected to the second cleaner unit during energization, and
wherein the first sensor has a larger horizontal angle in a detection range than the second sensor.

4. The cleaner system according to claim 1,
wherein a detection range of the first sensor is set to a region forward of a detection range of the second sensor when viewed from the vehicle.

5. The cleaner system according to claim 1,
wherein the first sensor is a LiDAR, and
wherein the second sensor is a camera.

6. The cleaner system according to claim 1,
wherein a detection range of the first sensor is wider than a detection range of the second sensor.
